(19) United States
(12) Patent Application Publication
(10) Pub. No.: US 2010/0079901 A1
(43) Pub. Date: Apr. 1, 2010

(54) PRODUCTION METHOD FOR MAGNETIC RECORDING MEDIA AND MAGNETIC RECORDING AND REPRODUCING APPARATUS

(75) Inventor: Masato FUKUSHIMA, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 12/550,159

(22) Filed: Aug. 28, 2009

(30) Foreign Application Priority Data
Sep. 1, 2008 (JP) 2008-223725

(51) Int. Cl. G11B 21/02; G11B 5/84

(52) U.S. Cl. 360/75; 427/127; G9B/21.003

(57) ABSTRACT

A production method for a magnetic recording medium on which a stable lubricant layer can be formed even if unevenness remains on the surface, and the thickness of the lubricant layer is not reduced over time is provided. The method includes forming a lubricant layer (12) on a surface of a magnetic recording medium (30) by the steps of: applying, onto the surface of the magnetic recording medium (30), a first lubricant (12a) with high wettability of the surface of the magnetic recording medium (30) with respect to the lubricant; and applying a second lubricant (12b) onto the surface of the magnetic recording medium (30) onto which the first lubricant (12a) has been applied.

### CROSS REFERENCE TO RELATED APPLICATION

This application claims priority of Japanese Patent Application No. 2008-223725 filed Sep. 1, 2008, the content of which is incorporated herein by reference in its entirety.

### BACKGROUND OF THE INVENTION

1. Field of the Invention

The present invention relates to a production method for a magnetic recording medium used for a hard disk device and to a magnetic recording and reproducing apparatus.

2. Description of the Related Art

Recently, applicability of magnetic recording devices, such as magnetic disk devices, flexible disk devices and magnetic tape devices, has increased significantly and their importance has also increased. Recording density of these magnetic recording media used for these devices has been increased significantly. With the advent of technologies regarding a magnetoresistive head and partial response maximum likelihood (PRML), surface recording density has improved still more significantly. In recent years, recording heads including GMR heads and TMR heads have also been introduced, which has further increased the surface recording density by about twofold a year. Regarding these magnetic recording media, there is a demand further increasing the recording density in the future. It is therefore necessary to increase coercive force, signal-to-noise ratio (SNR) and resolution of the magnetic layer. In recent years, efforts to increase the surface recording density have been made by increasing track density simultaneously with increasing linear recording density.

The most recent magnetic recording media have track density of as high as 110 kTPI. As the track density increases, however, magnetic recording information between adjacent tracks begins interfering with each other. As a result, a magnetizing transition area of a border area becomes a noise source, which may easily decrease the SNR. The decrease in the SNR may directly lead to a decrease in a bit error rate and prevent an improvement in recording density.

In order to increase the surface recording density, it is necessary to make the size of each recording bit on the magnetic recording medium finer and to secure the biggest possible saturation magnetization and the magnetic film thickness to each recording bit. However, as the recording bit becomes finer, the magnetizing minimum volume per 1 bit becomes small and recorded data may disappear by flux reversal caused by heat fluctuation.

Since the adjacent tracks come close to each other, a very highly precise track servo technique is necessary for the magnetic recording device. Usually, information is recorded on a wide track and reproduced in a narrower track in order to reduce influence from adjacent tracks to the minimum. Although influence between the tracks can be suppressed to the minimum by this method, it is difficult to obtain a sufficient reproduction output and it is thus difficult to provide a sufficient SNR.

In order to address the problems of the heat fluctuation and reliablity of the SNR or to provide sufficient outputs, unevenness along the track is formed on the surface of the recording medium so as to isolate the recording tracks physically or magnetically from one another to increase the track density. Such a technique will be called herein a discrete track method and a magnetic recording medium produced thereby will be called a discrete track medium.

An exemplary discrete track medium is a magnetic recording medium which is formed on a non-magnetic substrate having an uneven pattern formed thereon and a physically-isolated magnetic recording track and a servo signal pattern are formed on the medium (see, for example, Patent Document 1). In the disclosed magnetic recording medium, a ferromagnetic layer is formed via a soft magnetic layer on the substrate surface with unevenness. A protective film is formed on the surface of the ferromagnetic layer. In this magnetic recording medium, a physically-isolated magnetic recording area is formed around a raised area.

According to the disclosed magnetic recording medium, generation of a magnetic wall on the soft magnetic layer can be avoided, influence of the heat fluctuation can thus be made small and no interference occurs between adjacent signals. As a result, a high-density magnetic recording medium with less noise can be provided. The discrete track method includes a method of forming a track after a magnetic recording medium consisting of several layers of thin films is formed, and a method of forming an uneven pattern on a substrate surface directly or on a thin film layer for track formation, and then forming a thin film of a magnetic recording medium (see, for example, Patent Documents 2 and 3). The former process is often called a magnetic layer processing. The latter process is often called an embossing process.

Patent Document 4 discloses a method of forming an area between magnetic tracks of a discrete track medium by injecting nitrogen ions and oxygen ions into a previously formed magnetic layer or by irradiating with laser. Patent Document 5 discloses employing carbon as a mask used for an ion milling process of the magnetic layer. Patent Document 6 discloses forming a ferromagnetic material layer including one of the elements of Fe, Co and Ni on a substrate, selectively masking a surface of the ferromagnetic material layer, exposing an exposed section with reactant gas including halogen and chemically modifying a magnetic property of the exposed section and a layer therebelow by chemical reaction to form a non-ferromagnetic material area.

A protective layer of hard carbon is formed on a surface of the magnetic recording medium. The protective layer protects information recorded on the recording layer from being accidentally interfered with by the magnetic head. The protective layer increases slidability of the magnetic head. However, since durability of the magnetic recording medium is still insufficient by providing the protective layer, a lubricant is applied to the surface of the protective layer to the thickness of about 0.5 to10 nm so as to improve durability of the protective layer. Examples of the lubricant include a perfluoropolyether-based lubricant and an aliphatic hydrocarbon-based lubricant. The lubricant is made to adhere to the protective layer so as to mainly prevent the magnetic head slider from directly interfering with the protective layer and to significantly reduce frictional force of the magnetic head slider which slides on the magnetic recording medium.

Patent Document 1: Japanese Unexamined Patent Application, First Publication No. 2004-164692

Patent Document 2: Japanese Unexamined Patent Application, First Publication No. 2004-178793

Patent Document 3: Japanese Unexamined Patent Application, First Publication No. 2004-178794

Patent Document 4: Japanese Unexamined Patent Application, First Publication No. 5-205257

Patent Document 5: Japanese Unexamined Patent Application, First Publication No. 2006-31849

Patent Document 6: Japanese Unexamined Patent Application, First Publication No. 2002-359138

### SUMMARY OF THE INVENTION

Generally, a magnetic recording medium having a discrete pattern or a bit pattern is produced by forming a magnetic layer of which the surface has recessed areas and raised areas and then filling up the recessed areas with a non-magnetic material so as to smooth the surface. If, however, a magnetic recording medium is produced by forming a mask layer corresponding to the magnetic pattern on the surface of the magnetic layer, partially non-magnetizing the magnetic layer by doping ions or other substances and forming a magnetic pattern on the magnetic layer, the surface of the magnetic recording medium is smoothed without being filled with the non-magnetic material.

There has been a problem that, if the surface of the magnetic recording medium is uneven and thus is not smooth, a lubricant cannot be applied uniformly onto the surface of the magnetic recording medium. Even if the lubricant layer is once formed uniformly, the thickness of the lubricant layer may be reduced over time, which may cause a crash of the magnetic recording reproducing head within the hard disk drive.

The invention provides a production method for a magnetic recording medium with a discrete pattern or a bit pattern, in which a lubricant layer can be reliably formed even on a surface on which unevenness still remains and thickness of the lubricant layer is not reduced over time.

In view of the production methods for magnetic recording media disclosed in the foregoing Patent Documents, the present inventors have developed a method of partially non-magnetizing a magnetic layer by providing a mask layer corresponding to the magnetic pattern on the surface of the magnetic layer and causing the surface of the magnetic layer exposed through the mask layer to chemically react with oxygen gas or other substance.

The present inventors have also found that, when the method is employed, reactivity between the oxygen gas or other substance and the magnetic layer is increased if a surface of a reaction area of the magnetic layer is slightly removed.

The thus-obtained magnetic recording medium has minor unevenness on a surface thereof. It is preferred to eliminate the unevenness by filling the recessed areas with a non-magnetic material. The smoothing process to fill the non-magnetic material, however, may probably contaminate the surface of the magnetic recording medium. The manufacturing process may also become complicated, which may increase the cost of the magnetic recording medium. Accordingly, the smoothing process is difficult to be employed. Accordingly, in order to obtain a clean magnetic recording medium surface, unevenness within tolerance is left on the surface of the magnetic recording medium.

If a lubricant layer is formed on an uneven surface of the magnetic recording medium, the lubricant cannot be applied uniformly as described above. Even if the lubricant layer is once formed uniformly, the thickness of the lubricant layer may be reduced over time, which may cause a crash of the magnetic recording reproducing head within the hard disk drive.

In order to solve the aforementioned problems, the present inventors have intensively studied and finally completed the invention. The invention relates to the following.

(1) A production method for a magnetic recording medium which includes, on at least one surface of a non-magnetic substrate, a magnetic pattern formed by magnetically isolating a magnetic layer when seen from a side of a surface of the magnetic recording medium, the magnetic pattern being formed by the magnetic layer and an isolated area defined around the magnetic layer, and the isolated area having a recessed area with respect to the magnetic pattern, the method including forming a lubricant layer on a surface of the magnetic recording medium by the steps of applying, onto the surface of the magnetic recording medium, a first lubricant with high wettability of the surface of the magnetic recording medium with respect to the lubricant; and applying a second lubricant onto the surface of the magnetic recording medium onto which the first lubricant has been applied.

(2) The production method for a magnetic recording medium according to (1), in which a molecular weight of the first lubricant is smaller than that of the second lubricant.

(3) The production method for a magnetic recording medium according to (1) or (2), in which after the first lubricant is applied to the surface of the magnetic recording medium, the first lubricant applied to the surface of the magnetic recording medium is partially washed out and then the second lubricant is applied to the surface of the magnetic recording medium.

(4) The production method for a magnetic recording medium according to any one of (1) to (3), in which the surface of the magnetic recording medium is washed with water before the first lubricant is applied to the surface of the magnetic recording medium.

(5) A magnetic recording and reproducing apparatus which includes in combination: a magnetic recording medium produced by the production method for a magnetic recording medium according to any one of (1) to (4); a driving section which drives the magnetic recording medium toward a recording direction; a magnetic head which includes a recording section and a reproducing section; a device for causing the magnetic head to relatively move with respect to the magnetic recording medium; and a recording and reproducing signal processing device which inputs signals to the magnetic head and reproduces output signals from the magnetic head.

According to the invention, in the magnetic recording medium having a discrete pattern or a bit pattern, a lubricant layer can be provided reliably even if unevenness remains on the surface of the magnetic recording medium. Thus, a reliable magnetic recording and reproducing apparatus can be provided.

### BRIEF DESCRIPTION OF THE DRAWINGS

FIG. 1 schematically illustrates a state of a lubricant on a surface of a magnetic recording medium to which the invention is applied.

FIG. 2 schematically illustrates a section structure of a substrate and a magnetic layer of the magnetic recording medium according to an embodiment to which the invention is applied.

FIG. 3 is a flowchart schematically illustrating an exemplary production method for the magnetic recording medium according to the invention.

FIG. 4 illustrates a configuration of a magnetic recording and reproducing apparatus according to the invention.

FIG. 5 schematically illustrates a state of a lubricant on a surface of a related art magnetic recording medium.

### DESCRIPTION OF REFERENCE NUMERALS

1: non-magnetic substrate

2: magnetic layer

3: carbon mask layer

4: resist layer

5: stamp

6: ion milling

7: removed portion

8: resist layer

9: protective film layer

10: oxygen or ozone

11: inactive gas

12: lubricant layer

12a: first lubricant

12b: second lubricant

21: magnetic property decreased area

22: recessed area

23: raised area

30: magnetic recording medium

31: magnetic head

32: recording and reproducing signal system

33: head driving section

34: medium driving section

41: magnetic recording and reproducing device

### DETAILED DESCRIPTION OF THE INVENTION

Hereinafter, a production method for a magnetic recording medium and a magnetic recording and reproducing apparatus to which the invention is applied will be described in detail with reference to the drawings.

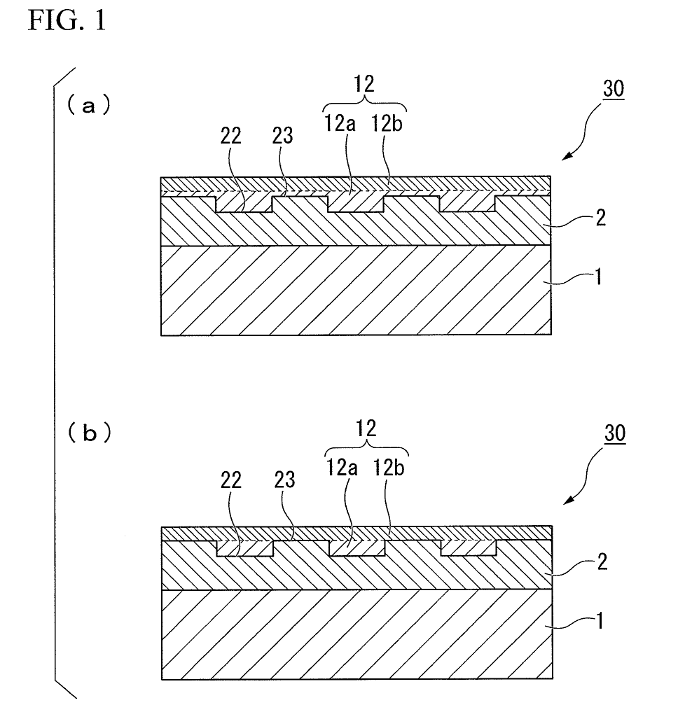

First, a configuration of a lubricant layer 12 formed on a surface of a magnetic recording medium 30 as illustrated in FIG. 1 will be described as an embodiment of the invention. As illustrated in FIGS. 1(a) and 1(b), the lubricant layer 12 adheres to a surface of a protective layer (not shown) formed on the surface of the magnetic recording medium 30 so as to prevent a magnetic head slider from directly interfering with the protective layer. The lubricant layer 12 significantly reduces frictional force of the magnetic head slider which slides on the magnetic recording medium 30.

The invention relates to a production method for the magnetic recording medium 30. The magnetic recording medium 30 has a magnetic pattern on at least one surface of the non-magnetic substrate 1 formed by magnetically isolating the magnetic layer 2. The magnetic pattern includes the magnetic layer 2 and an isolated area formed around the magnetic layer 2 when seen from the lubricant layer 12 side. The isolated area forms a recessed area 22 with respect to the magnetic pattern. A lubricant layer 12 is formed on the surface of the magnetic recording medium 30 by applying, onto the surface of the magnetic recording medium 30, a first lubricant 12a for improving wettability of the surface of the magnetic recording medium 30 with respect to a second lubricant, and then applying the second lubricant 12b onto the surface of magnetic recording medium 30 on which the first lubricant 12a has been applied.

In a related art production method for a magnetic recording medium, since a surface of a magnetic recording medium is very smooth, when a lubricant is applied to the surface of the magnetic recording medium, the lubricant spreads on the surface uniformly so as to provide a lubricant layer of uniform thickness over the entire surface of the magnetic recording medium.

On the contrary, when unevenness remains on the surface as in the magnetic recording medium of the invention, a problem may arise that the lubricant cannot be applied uniformly. In addition, even if the lubricant is once applied to the entire surface to form a lubricant layer, the thickness of the lubricant layer will be reduced over time due to space formed inside the lubricant layer. Thus, there is a possibility that the magnetic recording reproducing head may crash within the hard disk drive.

The present inventors have further examined this phenomenon and found that, as illustrated in FIG. 5(a), for example, when the lubricant 112 is applied to the surface of the magnetic recording medium 130 with unevenness remaining thereon, the lubricant gathers to an edge portion of the raised area 123 on the surface of the magnetic recording medium 130. Thus, the lubricant layer 112 cannot be uniformly formed on the surface of the magnetic recording medium 130. It has been also found that, as illustrated in FIG. 5(b), for example, since the gathered lubricant moves toward an upper surface of a recessed area 122 or a raised area 123 over time, the thickness of the lubricant layer 112 at the raised areaside surface of the magnetic recording medium may be reduced. As a result, protection performance of the lubricant layer 112 may be impaired and the magnetic recording reproducing head may crash.

In order to solve these problems, in the invention, a lubricant layer is formed uniformly on the entire magnetic recording medium by applying a first lubricant having high wettability with respect to the surface of the magnetic recording medium onto the surface of the magnetic recording medium, and then a step of applying a second lubricant onto the surface of the magnetic recording medium on which the first lubricant has been applied. Here, the term “first lubricant with high wettability” means the first lubricant having higher wettability than that of the second lubricant. After the first lubricant is applied uniformly on the surface of the magnetic recording medium, the second lubricant can be uniformly applied to the surface of the magnetic recording medium. For example, as illustrated in FIG. 1(a), after the first lubricant 12a is applied to the surface of the magnetic recording medium 30 and the wettability with respect to the second lubricant of the surface of the magnetic recording medium 30 is increased, the second lubricant 12b is applied to the surface of the magnetic recording medium 30. In this manner, the lubricant layer 12 is uniformly formed over the entire surface of the magnetic recording medium.

The lubricant layer 12 used in the invention is not particularly limited so long as it is chemically stable, low in frictional coefficient and in adsorption. Examples thereof may include a fluoro-resin-based lubricant. Examples of widely used fluoro-resin-based lubricant include perfluoropolyether. Examples of perfluoropolyether include Fomblin Z-DOL and Fomblin Z-TETRAOL (trade names) available from Solvay Solexis.

These substances may be used alone or in combination. For example, a cyclotriphosphazene-based lubricant and a perfluoropolyether-based lubricant may be used in combination, and a perfluoropolyether compound having a phosphazene ring at a terminal group and a perfluoropolyether compound having a hydroxyl group at a terminal group may be used in combination as a lubricant.

The above-described fluoro-resin-based lubricant is often dissolved or dispersed in a fluorine-based solvent and is applied to a protective film formed on the surface of the magnetic recording medium 30. Examples of the method of applying the fluoro-resin-based lubricant may include spin-coating the solution including the lubricant onto the surface of the magnetic recording medium 30. Alternatively, a solution is placed in a lubricant storage tank in which a magnetic recording medium 30 is immersed, then the magnetic recording medium 30 is taken out of the lubricant storage tank at a predetermined speed so as to form a lubricant film of uniform thickness on the surface of the magnetic recording medium 30 (dipping). Examples of the fluorine-based solvent used for dissolution of the fluoro-resin-based lubricant may include Vertrel XF (trade name) available from DuPont-Mitsui Fluorochemicals.

The first lubricant 12a and the second lubricant 12b which constitute the lubricant layer 12 of the invention may be the same or different compounds. If different compounds are employed, the first lubricant 12a and the second lubricant 12b may have the same molecular weight.

If the first lubricant 12a and the second lubricant 12b which constitute the lubricant layer 12 are different compounds and used in the same molecular weight, the average molecular weight is preferably in the range of 500 to 5000 and more preferably in the range of 500 to 3000. The average molecular weight of less than 500 is not preferred since the lubricant is easily vaporized while the hard disk drive is in operation and lubricating performance becomes insufficient. The average molecular weight exceeding 5000 is also not preferred since viscosity unfavorably increases and mobility and applicability deteriorate. The average molecular weight in the range described above preferably provides excellent mobility, applicability and temporal stability.

Since the first lubricant 12a and second lubricant 12b of the lubricant layer 12 are fundamentally similar in type, it is considered that both the lubricants diffuse into each other after applying the second lubricant 12b. Accordingly, as shown in the schematic diagram illustrated in FIGS. 1(a) and 1(b), it is considered that the boundary of the first lubricant 12a and the second lubricant 12b is not defined clearly. However, it is considered that the outermost surface of the lubricant layer 12 is covered with the second lubricant 12b.

In the invention, it is preferred that organic compounds of the same structure with varying degree of polymerization are used as the first lubricant 12a and the second lubricant 12b. It is also preferred that the molecular weight of the first lubricant 12a is smaller than that of the second lubricant 12b.

It is generally known that a lubricant with increased molecular weight has a higher boiling point and increased high temperature stability. Accordingly, since the temperature inside the hard disk drive often reaches as high as 80° C. depending on the usage environment, a lubricant with high molecular weight is often used. Since a lubricant with high molecular weight has high viscosity, however, if the lubricant is applied to an uneven surface of the magnetic recording medium, the lubricant especially gathers easily on the surface.

Accordingly, in the invention, coverage of the lubricant on the surface of the magnetic recording medium 30 with unevenness remaining thereon is increased by using a lubricant with low molecular weight as the first lubricant 12a. At the same time, wettability thereof with respect to the second lubricant is increased. It is preferred to then apply the second lubricant 12b to the surface of the magnetic recording medium 30 on which the first lubricant 12a has been applied, in order to form a lubricant layer 12 over the entire surface of the magnetic recording medium 30.

Here, the first lubricant 12a has an average molecular weight of preferably in the range of 500 to 2500 and more preferably in the range of 500 to 2000. The second lubricant 12b has an average molecular weight of preferably higher than that of the first lubricant 12a, which is preferably in the range of 1000 to 4000 and more preferably in the range of 1500 to 3000.

In the invention, after the first lubricant 12a is applied to the surface of the magnetic recording medium 30, the magnetic recording medium 30 is immersed in a solvent so as to partially wash the first lubricant 12a adhering to the surface of the magnetic recording medium 30. Then, the second lubricant 12b is preferably applied to the surface of the magnetic recording medium 30. As described above, although a lubricant with low molecular weight has low viscosity and thus applicability to the surface of the magnetic recording medium with unevenness is high, since a boiling point thereof is low, protection of the surface of the magnetic recording medium is not high. Accordingly, as illustrated in FIG. 1(b), after the wettability of the surface of the magnetic recording medium 30 with respect to the second lubricant is increased by applying, to the surface of the magnetic recording medium 30, the first lubricant 12a having smaller molecular weight than that of the second lubricant 12b, the magnetic recording medium 30 is immersed in a solvent to wash excess substances of the first lubricant 12a adhering to the surface of the magnetic recording medium 30. Then, the second lubricant 12b is applied to the magnetic recording medium 30. In this manner, the lubricant layer 12 having high molecular weight and high boiling point can be applied uniformly. In the invention, it is preferred to employ a fluorine-based solvent as a solvent that can be used for washout of the first lubricant. Preferred examples of the fluorine-based solvent include Vertrel XF (trade name) available from DuPont-Mitsui Fluorochemicals.

It is also preferred in the invention that, before applying the first lubricant 12a to the surface of the magnetic recording medium 30, the surface of the magnetic recording medium 30 is washed with water. Washing the surface of the magnetic recording medium 30 with water has the following effects: dust adhering to the surface of the magnetic recording medium 30 can be removed; wettability of the surface of the magnetic recording medium 30 with respect to the lubricant is increased; and the lubricant layer 12 is uniformly formed on the surface of the magnetic recording medium 30.

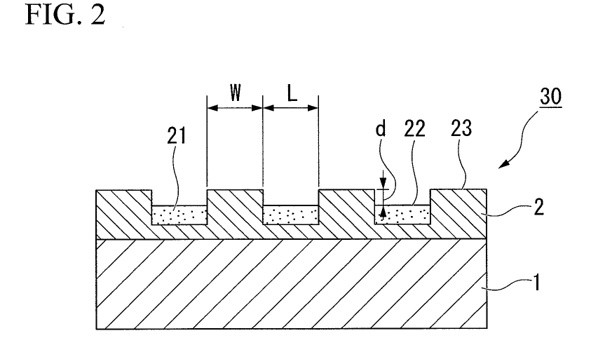

Next, the magnetic recording medium applied to the present embodiment is described in detail with reference to FIG. 2. In the present embodiment, although the production method for a magnetic recording medium of a discrete pattern is used, a similar production method for a magnetic recording medium of bit pattern can also be used.

As illustrated in FIG. 2, the magnetic recording medium 30 applied to the present embodiment is formed by laminating, on a surface of non-magnetic substrate 1, a soft magnetic layer, an intermediate layer, a magnetic layer 2 and a protective film layer. The magnetic layer 2 includes a magnetic area and an isolated area in which the magnetic pattern is formed.

A lubricating film is formed on an outermost surface of the magnetic recording medium 30. A magnetic area which is a magnetic pattern area is isolated by the isolated area. Only the substrate 1 and the magnetic layer 2 are illustrated in FIG. 2.

On the magnetic layer 2, the surface sections at certain areas are removed to provide recessed areas 22. Here, d represents the depth of the recessed area 22. The bottom of the recessed area 22 is formed as an area 21 at which a magnetic property has been decreased through, for example, non-magnetization (hereinafter, referred to as a “magnetic property decreased area”).

As illustrated in FIG. 2, the magnetic layer 2 is isolated by the magnetic property decreased area 21 and the recessed area 22 to provide a raised area 23 serving as a magnetic area. In the present embodiment, the magnetic property decreased area 21 is also included in the non-magnetized area.

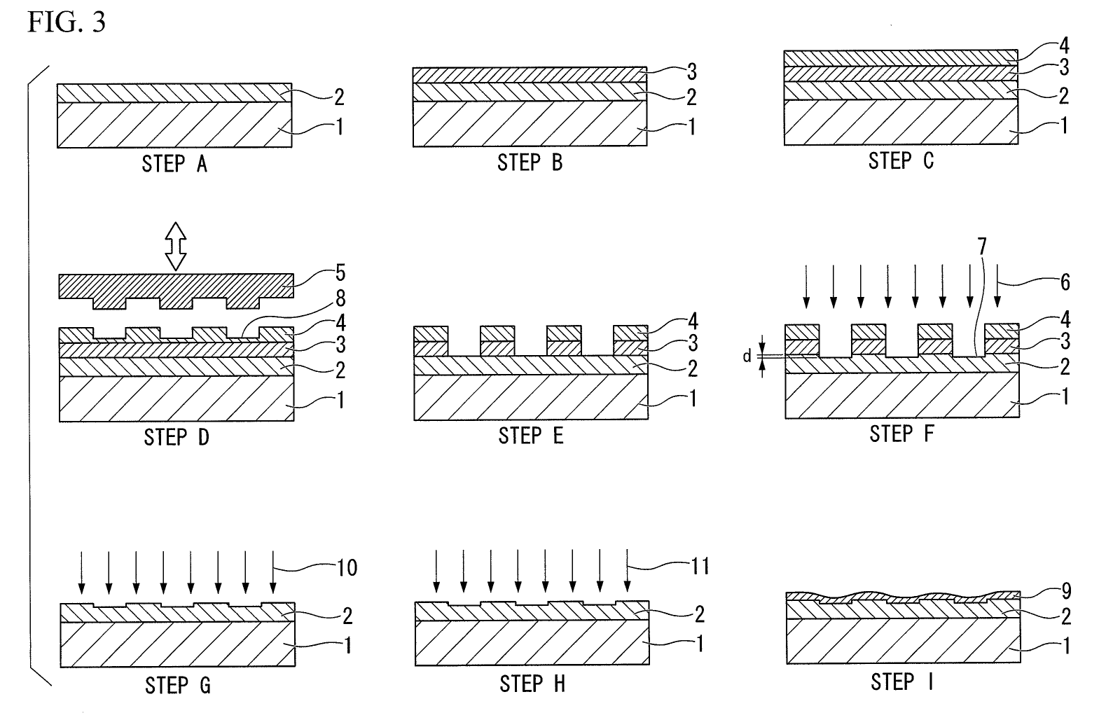

Next, the production method for of the magnetic recording medium 30 of the present embodiment will be described in detail with reference to FIG. 3.

As illustrated in FIG. 3, the production method for the magnetic recording medium 30 includes, in this order: a step A of forming at least the magnetic layer 2 on the non-magnetic substrate 1; a step B of forming the carbon mask layer 3 on the magnetic layer 2; a step C of forming a resist layer 4 on the carbon mask layer 3; a step D of forming a negative pattern of a magnetic pattern on the resist layer 4 by transferring using a stamp 5 (the term “negative pattenr” herein is a pattern which has recessed areas formed in the resist layer corresponding to the recording track in order to isolate the recording track) (an arrow in the step D represents a motion of the stamp 5 and the reference numeral 8 represents a resist layer remaining after the formation of the negative pattern); a step E of removing a portion corresponding to the negative pattern of the magnetic pattern from the resist layer 8 and the carbon mask layer 3 remaining even after the transfer; a step F of removing, by ion milling 6, an exposed surface section of the magnetic layer 2 remaining after the removal of the carbon mask 3 (reference numeral 7 represents the removed portion); and a step G which includes forming a non-magnetized area on the magnetic layer 2 from which the surface section has been removed, exposing the formed area to, for example, oxygen and ozone 10 or irradiating the formed area with laser, and subsequently removing the resist 4 and the carbon mask layer 3.

In addition to the above-described steps, it is preferred to expose a surface to fluorine-based gas before the step of forming the non-magnetized area at the portion corresponding to the negative pattern of the magnetic pattern of the magnetic layer 2. It is also preferred to provide a step H of irradiating inactive gas 11, such as Ar, to slightly remove the surface section of the magnetic layer 2 and a step I of forming a protective film layer 9 on the removed area after the resist layer 4 and the carbon mask layer 3 are removed.

The non-magnetic substrate 1 may be any substrate so long as it is a non-magnetic substrate. Examples thereof include an Al alloy substrate, such as Al—Mg alloy, having Al as a principle component, and substrates of normal soda glass, aluminosilicate-based glass, crystallized glass silicon, titanium, ceramic and various resins. Among these, glass substrates, such as an Al alloy substrate and crystallized glass, or silicon substrates are preferably used. Average surface roughness (Ra) of these substrates is not more than 1 nm, preferably not more than 0.5 nm and more preferably not more than 0.1 nm.

An in-plane magnetic layer or a perpendicular magnetic layer can be used as the magnetic layer 2. The perpendicular magnetic layer is especially preferable from the viewpoint of high recording density. The magnetic layer 2 is preferably produced by a Co-based alloy.

Here, as a magnetic layer for an in-plane magnetic recording medium, for example, a lamination structure consisting of a non-magnetic CrMo underlayer and a ferromagnetic CoCrPtTa magnetic layer can be used.

As a magnetic layer for a perpendicular magnetic recording medium, for example, a lamination structure consisting of a backing layer of, for example, an FeCo alloy (e.g., FeCoB, FeCoSiB, FeCoZr, FeCoZrB and FeCoZrBCu) having a soft magnetic property, a FeTa alloy (e.g., FeTaN and FeTaC) and a Co alloy (e.g., CoTaZr, CoZrNB and CoB), an orientation controlling film, such as Pt, Pd, NiCr and NiFeCr, an intermediate layers, which will be provided as necessary, and a magnetic layer having a granular structure consisting of a 67Co-18Cr-15Pt alloy or a 70Co-5Cr-15Pt-10SiO₂ alloy may be used.

In the present embodiment, a magnetic layer having a granular structure is preferably employed as the magnetic layer 2 from the viewpoint of increasing reactivity at the time of forming a non-magnetized area. The magnetic layer having the granular structure herein is a magnetic layer in which an oxide covers the circumference of the magnetic particle.

Examples of the oxide include a Ti oxide, a W oxide, a Cr oxide, a Co oxide, a Ta oxide and a Ru oxide other than the above-described SiO₂.

The thickness of the magnetic layer 2 is not less than 3 nm and not more than 20 nm and preferably not less than 5 nm and not more than 15 nm. It suffices that the magnetic layer 2 is formed to provide sufficient input and output performance of the head in accordance with the type and the lamination structure of the magnetic alloy used. The thickness of the magnetic layer 2 is defined to obtain predetermined output greater than certain output at the time of reproduction. Usually, since parameters representing the recording reproduction characteristic are reduced as the output increases, it is therefore necessary to determine the optimum thickness. The magnetic layer 2 is formed as a thin film by sputtering.

In the present embodiment, the carbon mask layer 3 which includes a carbon film is formed on the surface of the magnetic layer 2. Since the carbon film which constitutes the carbon mask layer 3 is easy in dry etching (i.e., reactive ion etching or reactant ion milling) using oxygen gas, residue can be reduced and contamination on the surface of the magnetic recording medium 30 can be decreased in the step G in FIG. 3.

The carbon film can be formed by sputtering or by a CVD process. The CVD process can form a carbon film with a higher compactness. The thickness of the carbon mask layer 3 is preferably in the range of 5 nm to 40 nm and more preferably in the range of 10 nm to 30 nm. If the thickness of the carbon mask layer 3 is smaller than 5 nm, the edge portion of the carbon mask layer 3 may be rolled off, which may impair the formation characteristic of the magnetic pattern. It is not preferred that the ion that transmitted the resist layer 4 and the carbon mask layer 3 enters the magnetic layer 2 and impairs the magnetic property of the magnetic layer 2. If the thickness of the carbon mask layer 3 is thicker than 40 nm, longer etching time of the carbon mask layer 3 is necessary and productivity thus decreases. Further, residue during etching of the carbon mask layer 3 may unfavorably remain on the surface of the magnetic layer 2.

Next, a resist layer 4 is formed on the carbon mask layer 3. A negative pattern of the magnetic pattern is formed on the resist layer 4. Although the negative pattern can be formed on the resist layer by a normal photolithography method, it is preferred to use a stamp on the resist layer 4 to transfer a negative pattern of the magnetic pattern from the viewpoint of operation efficiency.

In the present embodiment, as illustrated in the step D in FIG. 3, it is preferred to define the thickness of the resist layer 8 remaining in the recessed area of the resist layer 4 after the negative pattern of the magnetic pattern is formed on the resist layer 4 in the range of 0 to 20 nm. When the thickness of the remained layer in the resist layer 4 is in contrtolled in this range, edge roll-off of the mask layer 3 during an etching process of the carbon mask layer 3 and the magnetic layer 2 can be avoided as illustrated in the step E in FIG. 3. At the same time, the shield ability with respect to the milling ion of the carbon mask layer 3 and the magnetic pattern formation characteristic by the carbon mask layer 3 can be improved.

In the present embodiment, it is preferred to employ a radiation-curable material for the resist layer 4 illustrated in the step C in FIG. 3. It is also preferred to irradiate the resist layer 4 with radiation during or after transferring a pattern onto the resist layer 4 using the stamp 5. Thus, the configuration of the stamp 5 can be transferred highly precisely onto the resist layer 4. In the etching process of the carbon mask layer 3 as illustrated in the step E in FIG. 3, edge roll-off of the carbon mask layer 3 can be avoided, and shield ability of the carbon mask layer 3 with respect to the milling ion can be improved and the magnetic pattern formation characteristic by the carbon mask layer 3 can be improved.

Examples of the radiation used in the present embodiment include a wide range of electromagnetic waves, such as heat ray, visible light, ultraviolet ray, X-ray and gamma ray. Examples of the radiation-curable material include heat-curing resin in case of the heat ray and ultraviolet curing resin in case of the ultraviolet ray.

In the present embodiment, in the step of transferreing a pattern onto the resist layer 4 using the stamp 5, the stamp 5 is pressed against the resist layer 4 in a state in which the mobility of the resist layer 4 is high. With the stamp 5 being pressed, the resist layer 4 is cured when irradiated with radiation. The stamp 5 is then removed from the resist layer 4. In this manner, the configuration of the stamp 5 can be transferred highly precisely to the resist layer 4.

Several methods are proposed to irradiate the reisist layer 4 with radiation while the stamp 5 is pressed against the resist layer 4. For example, the resist layer 4 may be irradiated at an opposite side of the stamp 5, i.e., a side of the substrate. The resist layer 4 may be irradiated at the side of the stamp 5 in a case in which the stamp 5 is made by a radiation-transmittive material. The resist layer 4 may be irradiated from a side surface of the stamp 5. The resist layer 4 may be irradiated by heat conduction of the stamp material or the substrate 1 using highly conductive radiation with respect to a solid material, such as heat ray. It is preferred to employ ultraviolet curing resin, such as novolak-based resin, acrylic ester resin and alicyclic epoxy resin, as a material of the resist layer 4. It is preferred to employ glass or resin which is highly transmittive to the ultraviolet ray as a material of the stamp 5.

The resist layer 4 is preferably made of SiO₂-based resist. The SiO₂-based resist is highly resistive to dry etching using oxygen gas. Thus, in a process of forming a negative pattern of a magnetic pattern using ion milling on the carbon mask layer 3, image blurring can be reduced. That is, since the carbon mask layer 3 can be easily worked by dry etching using oxygen gas while the SiO₂-based resist is highly resistive to dry etching using oxygen gas, it becomes possible to work the carbon mask layer 3 into a configuration to stand upright by dry etching which can provide a highly sharp magnetic pattern.

If the carbon mask layer 3 is removed and the resist remains in the recessed area after the formation of the negative pattern (the resist is denoted by a reference numeral 8 in the step D in FIG. 3), the resist 8 is removed (see the step E in FIG. 3). Dry etching, such as reactive ion etching and ion milling, is used for the removal of the carbon mask and the resist.

In the present embodiment, the area on the magnetic layer 2 that is not covered with the carbon mask layer 3 and the resist layer 4 is non-magnetized in the foregoing method. Before the non-magnetization, the magnetic layer 2 at that area is removed. The surface section (d illustrated in the step F in FIG. 3) of the magnetic layer 2 is preferably removed to a thickness range of 0.1 nm to 15 nm. The surface section of the magnetic layer 2 may deteriorate under the influence of the carbon mask layer 3 laminated thereon or the influence of the atmosphere. If the surface section deteriorates, the non-magnetizing reaction of the magnetic layer 2 may not work effectively.

The magnetic layer 2 is removed by dry etching the magnetic layer 2 in the ion milling succeedingly after the dry etching the carbon mask layer 3, for example by ion milling or reactive ion etching. In this manner, the edge portion of the remaining magnetic layer 2 can stand upright. This is because the carbon mask layer 3 is formed upright on the magnetic layer 2 and the magnetic layer 2 formed therebelow also has the similar configuration. In this manner, the magnetic layer 2 with excellent fringe performance can be provided.

As described above, it is preferred to perform reactive ion etching of the carbon mask layer 3 using oxygen gas in the present embodiment. It is also preferred to perform ion milling of the magnetic layer 2 using inactive gas, such as argon and nitrogen. That is, the milling ion for the carbon mask layer 3 and the milling ion for the magnetic layer 2 are preferably replaced with optimal milling ion.

It is preferred to expose an area on the magnetic layer 2 which is not covered with the carbon mask layer 3 and the resist layer 4 with fluorine-based gas before that area is subject to non-magnitization. In this manner, the reactivity of surface of the magnetic layer 2 is improved and the non-magnetizing reaction can be performed more efficiently.

In the present embodiment, it is preferred to employ a magnetic layer having a granular structure as the magnetic layer 2 as described above. The magnetic layer having a granular structure is a magnetic layer in which an oxide covers the circumference of a magnetic particle. Since the magnetic crystal is isolated by a non-magnetic phase, magnetic interaction between magnetic grains is weak. Since the magnetic crystal grain is fine, the magnetic layer of significantly low noise can be formed. If such a magnetic layer 2 is non-magnetized by using oxygen or ozone, an oxide layer existing in the grain boundary can be selectively etched by a process in a reactive ion etching device using, for example, fluorine-based gas. At the same time, oxidation reaction with metal, such as Co in the magnetic layer 2, and oxygen and ozone can be promoted, and thus the magnetic property of the magnetic layer 2 can be changed more efficiently.

In the present embodiment, the magentive layer 2 may have a two-layer structure of the granular structure and a non-granular structure formed thereon.

In the magnetic recording medium 30 of the present embodiment, as illustrated in FIG. 2, it is preferred that a width W of the magnetic section of the magnetic layer 2 is not greater than 200 nm and a width L of the non-magnetic part is not greater than 100 nm from the viewpoint of increase in recording density. Accordingly, the track pitch P (i.e., W+L) should be as small as possible and not greater than 300 nm in order to increase the recording density in the data area.

Here, in the magnetically-isolated magnetic pattern of the invention, it suffices that the magnetic layer 2 is isolated when seen from a surface side of the magnetic recording medium 30 even if it is not isolated at the bottom of the magnetic layer 2 in order to achieve the object of the invention. Such a magnetically-isolated magnetic pattern is also included in the scope of the magnetically-isolated magnetic pattern of the the invention. The magnetic pattern of the invention may include a bit pattern, a discrete pattern, a servo data signal pattern and a burst signal pattern. In the bit pattern, the magnetic pattern is disposed regularity for every 1 bit. In the discrete pattern, the magnetic pattern is disposed on a track pattern.

It is preferred to apply the present embodiment to a discrete pattern magnetic recording medium from the viewpont of simplicity in manufacture. In the discrete pattern magnetic recording medium, magnetically-isolated magnetic patterns are the magnetic recording track and servo signal patterns.

In the production of the magnetic recording medium 30 of the present embodiment, the resist layer 4 and the carbon mask layer 3 formed on the magnetic layer 2 are removed after the magnetic layer 2 is partially non-magnetized. It is preferred to remove the resist layer and the mask layer by dry etching, reactive ion etching or ion milling.

In production of the recording medium 30 of the present embodiment, the surface section is preferably etched using inactive gas, such as Ar, as illustrated in the step H in FIG. 3 to the thickness range of 1 nm to 2 nm in order to remove the outermost surface layer that is non-magnetized by ozone or other substances on the surface of the magnetic layer 2. This is because the surface of the magnetic layer 2 may become rough in this area.

In the present embodiment, as illustrated in the step I in FIG. 3, the protective film layer 9 is formed on the surface of the magnetic layer 2 after the resist layer 4 and the carbon mask layer 3 are removed (i.e., in a magnetic area (raised area 23), an area in which a non-magnetic material is buried (“magnetic property decreased area 21”) or an area of the recessed area 22 in which no non-magnetic material is buried as illustrated in FIG. 2).

The protective film layer 9 may be a carbonaceous layer consisting of carbon (C), hydrogenated carbon (HxC), carbon nitride (CN), amorphous carbon and silicon carbide (SiC), or other usually employed protective film layer material, such as SiO₂, Zr₂O₃ and TiN. The protective film layer 9 may include two or more layers.

The thickness of the protective film layer 9 needs to be not greater than 10 nm. The thickness of the protective film layer 9 greater than 10 nm is not preferred since the head and the magnetic layer are away from each other, which may cause the input and output signal intensity to become insufficient. The protective film layer 9 can be formed by sputtering or a CVD process.

The lubricant layer 12 is formed on the protective film layer 9 as described above (see FIGS. 1(a) and 1(b)). The lubricant layer 12 is usually formed to the thickness of 1 to 4 nm.

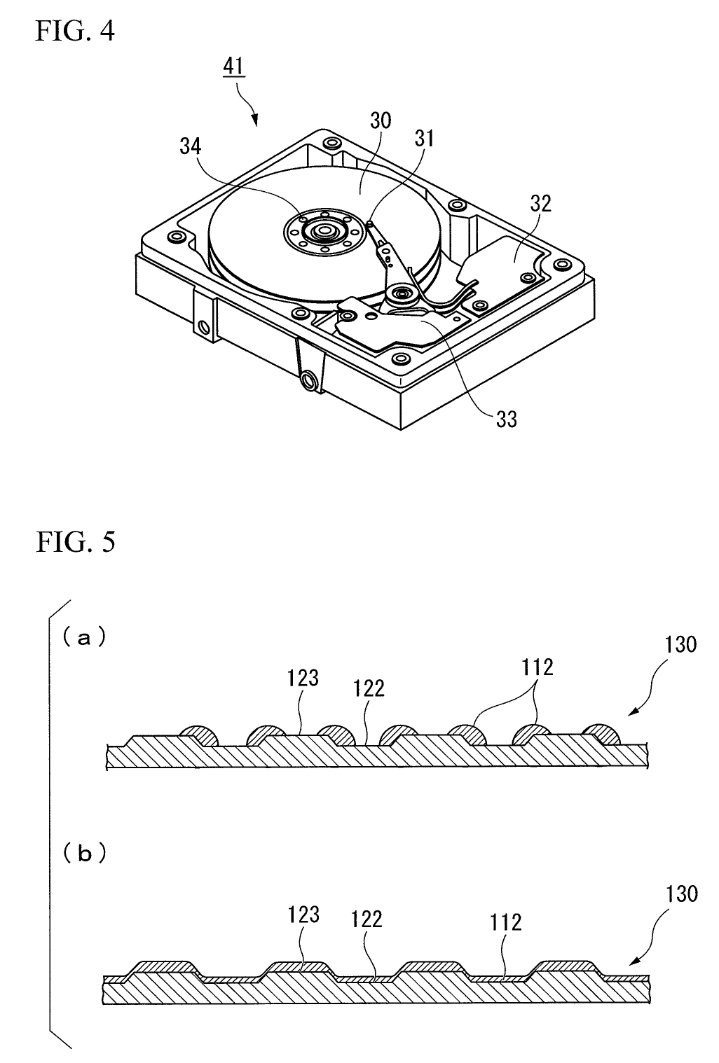

Next, a configuration of the magnetic recording and reproducing apparatus 41 to which the invention is applied is illustrated in FIG. 4. The magnetic recording and reproducing apparatus 41 according to the invention includes the magnetic recording medium 30, a medium driving section 34, a magnetic head 31, a head driving section 33 and a recording and reproducing signal system 32. The medium driving section 34 drives the magnetic recording medium 30 to a recording direction. The magnetic head 31 includes a recording section and a reproducing section. The head driving section 33 causes the magnetic head 31 to be relatively moved with respect to the magnetic recording medium 30. The recording and reproducing signal system 32 has a combined function of signal input to the magnetic head 31 and a recording and reproducing signal processing device for reproducing output signals from the magnetic head 31. A combination of these components can provide a magnetic recording and reproducing apparatus 41 with high recording density. In the related art, the width of the reproducing head has been narrower than that of the recording head in order to eliminate influence of magnetizing transition areas at track edge portions. In the invention, however, the reproducing head width and the recording head width are substantially the same because the magnetic track of the the magnetic recording medium 30 has a magnetically-discontinuous configuration. Accordingly sufficient reproduction output and high SNR can be obtained.

Further, when the reproducing section of the magnetic head 31 is made of a GMR head or a TMR head, sufficient signal strength can be obtained even under high recording density. Thus, a magnetic recording and reproducing apparatus 41 with high recording density can be provided. If the raising amount of the magnetic head 31 is controlled to 0.005 μm to 0.020 μm, which is lower than that of the related art, both the output and the device SNR are incrased. As a result, a high-capacity and highly-reliable magnetic recording and reproducing apparatus 41 can be provided. If a signal processing circuit of a maximum likelihood decoding system is introduced, the recording density can further be improved. A sufficiently high SNR can be provided even if the recording and reproducing are performed with the track density of not less than 100K tracks per inch, linear recording density of 1000 KB per inch and the recording density of not less than 100 GB per 1 square inch.

### Examples

Hereinafter, Examples and Comparative Examples will be described to further illustrate the effect of the invention. However, the invnention is not limited to these Examples.

### (Production of Magnetic Recording Medium)

A vacuum chamber with a glass substrate for the HD being placed therein was evacuated to less than 1.0×10⁻⁵ Pa in advance. The glass substrate used herein was crystallized glass constituted by Li₂Si₂O₅, Al₂O₃—K₂O, Al₂O₃—K₂O, MgO—P₂O₅ and Sb₂O₃—ZnO. The glass substrate was dimensioned such that an outer diameter was 65 mm, an innter diameter was 20 mm and an average surface roughness (Ra) was 2 Å.

On the glass substrate, thin layers are laminataed by DC sputtering in the following order: a ₆₀Fe₃₀Co₁₀B soft magnetic layer; a Ru intermediate layer; a 70Co-5Cr-15Pt-10SiO₂ alloy magnetic layer having a granular structure. A carbon mask layer was laminated thereon by a P-CVD process. The thickness of the 60Fe30Co10B soft magnetic layer was 60 nm, the thickness of the Ru intermediate layer was 10 rim, the thickness of the magnetic layer was 15 nm and the thickness of the carbon mask layer was 30 nm. A SiO₂ resist was spin-coated on the uppermost layer to the thickness of 100 nm.

A stamp was pressed against the resist layer at the pressure of 1 MPa (about 8.8 kgf/cm²) using a glass stamp having a negative pattern of the magnetic pattern. Then, the stamp was removed from the resist layer and the magnetic pattern was transferred to the resist layer. The magnetic pattern transferred to the resist layer had a 120 nm-wide circular shape at a raised area of the resist at the data area and had a 120 nm-wide circular shape at a recessed area of the resist. The thickness of the resist layer was 80 nm and the thickness of the recessed area (i.e., bottom) of the resist layer was about 5 nm. The resist layer recessed area was angled about 90 degrees with respect to the substrate surface.

First, the resist layer remaining in the recessed area was removed using CF₄ at 0.5 Pa and 40 seem with the plasma power of 200 W, the bias of 20 W and the etching time of 10 seconds.

Then, the carbon mask layer on the recessed area of the resist layer was removed by dry etching and the surface section of the magnetic layer was removed by ion etching. The conditions for dry etching on the carbon mask layer were using O₂ gas of 40 seem, pressure of 0.3 Pa, high-frequency plasma power of 300 W, DC bias of 30 W and etching time of 30 seconds.

The magnetic layer was produced using N₂ gas of 10 seem, pressure of 0.1 Pa, accelerating voltage of 300V and etching time of 5 seconds. The depth (d illustrated in the step F in FIG. 3) of the recessed area of the magnetic layer was about 1 nm. Then, areas not covered with the carbon mask layer on the magnetic layer were exposed to gaseous ozone. The magnetic layer was exposed to the gaseous ozone that flows at 40 sccm in the chamber under the conditions of 1 Pa and 10 seconds with the substrate temperature of 150° C.

The carbon mask layer and the resist layer on the surface of the magnetic recording medium were then removed by dry etching. Then, in an ion milling device, the surface of the magnetic layer was etched to the thickness range of about 1 nm to 2 nm using Ar gas of 10 seem, 0.5 Pa and 5 seconds. A carbon protective film was formed to the thickness of 5 nm by a CVD process.

### Example 1

A lubricant of perfluoropolyether (Tetraol (trade name)) having an average molecular weight of 1500 was applied to the thus-produced magnetic recording medium as a first lubricant to the thickness of I nm. Vertrel (trade name) was used as the solvent.

Concentration of the solution was 0.3 mass %. After the lubricant was applied, the magnetic recording medium was left for about 30 minutes. Then, a lubricant consisting of perfluoropolyether having an average molecular weight of 2200 was applied as a second lubricant to the thickness of 1 nm.

### Example 2

Although the first and the second lubricants were applied in the same manner as in Example 1, the surface of the magnetic recording medium was spin-washed with pure water before the first application of the lubricant. The spin washing was perfouned while supplying pure water to both sides of the magnetic recording medium at 5cc/second while the magnetic recording medium was rotated at 200 rpm.

### Example 3

Although the first and the second lubricant were applied in the same manner as in Example 1, a lubricant consisting of perfluoropolyether having an average molecular weight of 1000 was used as the first lubricant.

### Example 4

Although the first and the second lubricants were applied in the same manner as in Example 3, the magnetic recording medium was immersed in a solvent (Vertrel (trade name)) for 30 seconds between application of the first lubricant and application of the second lubricant. Thickness of the second lubricant was 1.5 nm. Thickness of the first lubricant after the magnetic recording medium was immersed in the solvent was 0.5 nm.

### Comparative Example

A lubricant of perfluoropolyether was applied to the magnetic recording medium to the thickness of 2 nm. Tetraol (trade name) consisting of perfluoropolyether and having an average molecular weight of 2200 was used as the lubricant.

### (Evaluation of Applicability of Lubricant to Magnetic Recording Medium)

In order to evaluate applicability of the lubricant to the magnetic recording medium, head contamination of the magnetic recording reproducing head when traveling in a raised manner on the magnetic recording medium prepared by Examples 1 to 4 and Comparative Example was evaluated. If the applicability of the lubricant to the surface of magnetic recording medium was poor, the lubricant adhered to the head which may easily contaminate the head.

The evaluation on the head contamination was performed by confirming a degree of head contamination when a magnetic certify test was conducted for 25 sheets (i.e., 50 surfaces) of the magnetic recording media under predetermined test conditions using a test head (Tiger3 (trade name) available from TDK/SAE). The evaluation result is shown in Table 1.

TABLE 1

| | Head Contamination |
|---|---|
| Example 1 | 3% |
| Exmaple 2 | 1% |
| Example 3 | 2% |
| Example 4 | 0% |
| Comparatice Example | 50% |

### (Evaluation Result)

As shown in Table 1, the degrees of head contamination of Examples 1 to 4 were almost less than 3% while the degree of head contamination of Comparative Example was 50%. From the result, it was confirmed that the head contamination caused by adhesion of the lubricant was controlled in Examples 1 to 4 to which the invention was applied.

### INDUSTRIAL APPLICABILITY

The invention is highly industrially applicable in that, since a lubricant can be uniformly applied to a surface having an uneven magnetic pattern formed thereon of a magnetic recording medium, there is little contamination or breakage of a magnetic recording reproducing head, and thus a reliable magnetic recording and reproducing apparatus can be provided.

It is apparent that the present invention is not limited to the above Examples but may be modified and changed without departing from the scope and spirit of the invention.

What is claimed is:

1. A production method for a magnetic recording medium, the magnetic recording medium comprised a non-magnetic substrate; a magnetic layer; and, on at least one surface of the non-magnetic substrate, a magnetic pattern formed by magnetically isolating the magnetic layer when seen from a side of a surface of the magnetic recording medium, and the magnetic pattern being formed by the magnetic layer and an isolated area defined around the magnetic layer, and the isolated area having a recessed area with respect to the magnetic pattern, wherein the production method comprises forming a lubricant layer on a surface of the magnetic recording medium by the steps of:
applying, onto the surface of the magnetic recording medium, a first lubricant with high wettability of the surface of the magnetic recording medium with respect to the lubricant applied to the surface of the magnetic recording medium; and
applying a second lubricant onto the surface of the magnetic recording medium onto which the first lubricant has been applied.

2. The production method for a magnetic recording medium according to claim 1, wherein a molecular weight of the first lubricant is smaller than that of the second lubricant.

3. The production method for a magnetic recording medium according to claim 1, wherein after the first lubricant is applied to the surface of the magnetic recording medium, the first lubricant applied to the surface of the magnetic recording medium is partially washed out and then the second lubricant is applied to the surface of the magnetic recording medium.

4. The production method for a magnetic recording medium according to claim 1, wherein the surface of the magnetic recording medium is washed with water before the first lubricant is applied to the surface of the magnetic recording medium.

5. A magnetic recording and reproducing apparatus comprising in combination:
a magnetic recording medium produced by the production method for a magnetic recording medium according to claim 1;
a driving section which drives the magnetic recording medium toward a recording direction;
a magnetic head which includes a recording section and a reproducing section;
a device for causing the magnetic head to relatively move with respect to the magnetic recording medium; and
a recording and reproducing signal processing device which inputs signals to the magnetic head and reproduces output signals from the magnetic head.
